(19) United States
(12) Patent Application Publication
(10) Pub. No.: US 2024/0317259 A1
(43) Pub. Date: Sep. 26, 2024

(54) COMMUNICATION OF AUTONOMOUS VEHICLE (AV) WITH HUMAN FOR UNDESIRABLE AV BEHAVIOR

(71) Applicant: GM Cruise Holdings LLC, San Francisco, CA (US)

(72) Inventors: Livia Johanna, San Francisco, CA (US); Tejeswara Reddy Pogula, San Francisco, CA (US); Kendal Sparks, New York, NY (US); Rachel Lee, San Francisco, CA (US); Steven Selzer, Oakland, CA (US); Eleanor Cady Wachsman, Sacramento, CA (US); Benjamin Kelman, San Francisco, CA (US); Brian Wong, San Francisco, CA (US)

(73) Assignee: GM Cruise Holdings LLC, San Francisco, CA (US)

(21) Appl. No.: 18/186,357

(22) Filed: Mar. 20, 2023

(51) Int. Cl. B60W 60/00; B60W 40/02; B60W 40/08

(52) U.S. Cl. CPC B60W 60/0013; B60W 40/02; B60W 40/08; B60W 60/0015; B60W 2050/0062; B60W 2420/403; B60W 2554/4046; B60W 2556/10

(57) ABSTRACT

AVs can communicate with humans for operational behaviors of the AVs. An AV behavior may be detected and classified as an undesirable AV behavior that would cause a negative sentiment of a person based on information of the AV behavior, information of the person, or both. The person may be a passenger of the AV or a person outside the AV. A message including information of the AV behavior is generated. The message includes information that can improve the person's sentiment or improve the performance (e.g., safety, passenger comfort, etc.) of the AV. The message may include one or more options for the person to provide feedback on the AV behavior. The person's feedback can be used to improve a classification model used to classify the AV behavior. The message may also include an option for the person to modify a ride provided by the AV to the person.

### TECHNICAL FIELD OF THE DISCLOSURE

The present disclosure relates generally to AVs and, more specifically, to communication of AVs with humans for unexpected AV behaviors.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

Figure (FIG.) 1 illustrates a system including a fleet of AVs that can provide services to users, according to some embodiments of the present disclosure;

FIG. 2 is a block diagram showing a fleet management system, according to some embodiments of the present disclosure;

FIG. 3 is a block diagram showing a sensor suite, according to some embodiments of the present disclosure;

FIG. 4 is a block diagram showing an onboard computer, according to some embodiments of the present disclosure;

FIG. 5 is a block diagram showing a vehicle-human communication manager, according to some embodiments of the present disclosure;

FIG. 6 illustrates a passenger compartment of an AV, according to some embodiments of the present disclosure;

FIG. 7 illustrates an example conversation of an AV with a passenger, according to some embodiments of the present disclosure;

FIG. 8 illustrates another example conversation of an AV with a passenger, according to some embodiments of the present disclosure; and

FIG. 9 is a flowchart showing a method of vehicle-human communication, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless services, such as ride services, delivery services, and so on. A person can request an AV to pick him/her up from a location and drop him/her off at another location. With the autonomous driving features of the AV, the person does not have to drive during the ride and can be a passenger of the AV. The AV can navigate from the pick-up location to the drop-off location with no or little user input. AVs can provide other driverless services too, such as delivery service. A person can request an AV to deliver one or more items from one location to another location, and the person does not have to drive or be a passenger of the AV for the delivery. However, it has been becoming a challenge that little information about AV behaviors in driverless operations is communicated to people who are involved in driverless operations of the AVs. The people may include, for example, passengers receiving driverless rides, drivers of other vehicles, pedestrians, law enforcement, humans controlling traffic, and so on.

Embodiments of the present disclosure provide a vehicle-human communication platform that facilitates communications of AVs with humans. An AV can generate one or more messages for communicating with a person about a behavior it has performed, is performing, or is about to perform in a driverless operation. A message may include one or more types of signals, such as text, audio, image (e.g., static image, animated image, video, etc.), light, other types of signals, or some combination thereof. The AV can present the one or more messages to the person. The AV may receive the person's response to the message(s) and can generate one or more additional messages based on the person's response.

In various embodiments of the present disclosure, AVs may include a vehicle-human communication manager that can communicate with humans for undesirable AV behaviors. The vehicle-human communication manager may be facilitated by an onboard computer of the AV. The vehicle-human communication manager can detect AV behaviors for a driverless operation of the AV and determine whether the AV behaviors are undesirable AV behaviors. An undesirable AV behavior is a behavior of an AV that can cause a negative sentiment of a person towards the driverless operation of the AV. Undesirable AV behaviors may include AV behaviors that are unexpected by people, AV behaviors causing discomfort of people, AV behaviors causing safety concerns of people, and so on. The vehicle-human communication manager may determine whether an AV behavior is undesirable by comparing one or more parameters of the AV behavior with one or more corresponding reference parameters. In an example where the AV behavior is deceleration (e.g., a brake), the vehicle-human communication manager may determine that the brake is an undesirable hard brake based on a determination that the deceleration of the brake is greater than a deceleration limit.

In some embodiments, the vehicle-human communication manager may make a personalized determination whether an AV behavior is undesirable as different people can have different tolerances or preferences. The vehicle-human communication manager may apply information of the person to make the determination. The information of the person may be sensor data generated by one or more sensors of the AV that have captured the person, information provided by the person, information of historical driverless rides taken by the person, and so on. In some embodiments, the vehicle-human communication manager may evaluate the severity of an undesirable AV behavior. For instance, the vehicle-human communication manager may determine a severity score that indicates a predicted level of dissatisfaction of the person for the AV's driverless operation given the undesirable AV behavior.

After determining that an AV behavior is undesirable to a person or after determining the severity score of the undesirable AV behavior, the vehicle-human communication manager may generate one or more messages. The message(s) may include, for example, an acknowledgment of the undesirable AV behavior, an explanation of the reason (e.g., an external stimulus) why the undesirable AV behavior was performed, one or more questions querying the person's condition or sentiment, one or more consequences (if any) of the undesirable AV behavior, one or more suggestions or instructions to the person given the undesirable AV behavior, and so on. In the example of hard brake, the message(s) may include an apology for the hard brake, a reason why the hard brake was necessary (e.g., another vehicle was going to swerve into the lane of the AV), a query whether the person is hurt by the hard brake, and so on. In some embodiments (e.g., embodiments where the driverless operation is for providing a ride to the person), the message(s) may also include one or more options for the person to modify one or more settings of the ride (e.g., destination, route, time, etc.), one or more settings of parts of the AV (e.g., temperature, seat positions, etc.), and so on.

The vehicle-human communication manager may receive the person's response to the message(s). In some embodiments, the vehicle-human communication manager can use the person's response for future communications with the person or other people. In an example, the vehicle-human communication manager may determine a tolerance or preference of the person for AV behaviors based on the person's response that indicates the person's sentiment towards the undesirable AV behavior. In another example, the vehicle-human communication manager may use a trained model to determine whether AV behaviors are undesirable to people and may use the person's response to further train the model.

The vehicle-human communication manager in the present disclosure enables AVs to have dynamic, unique, and personalized conversations with humans about AV behaviors in driverless operations. Message(s) provided by the vehicle-human communication manager to a passenger of an AV can help the passenger better understand why the AV performed undesirable behaviors and therefore, boost the passenger's comfort, trust, satisfaction, or retention for AV driverless rides. Message(s) provided to a person outside an AV can inform the person the status of the AV for the person to make an informed decision, which may improve the safety of the person or the AV itself. Thus, the vehicle-human communication manager in the present disclosure can enhance AVs' performance in their driverless operations by communicating with people who are involved in the driverless operations.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Example System with AV Fleet

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 135B, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a network, such as the Internet.

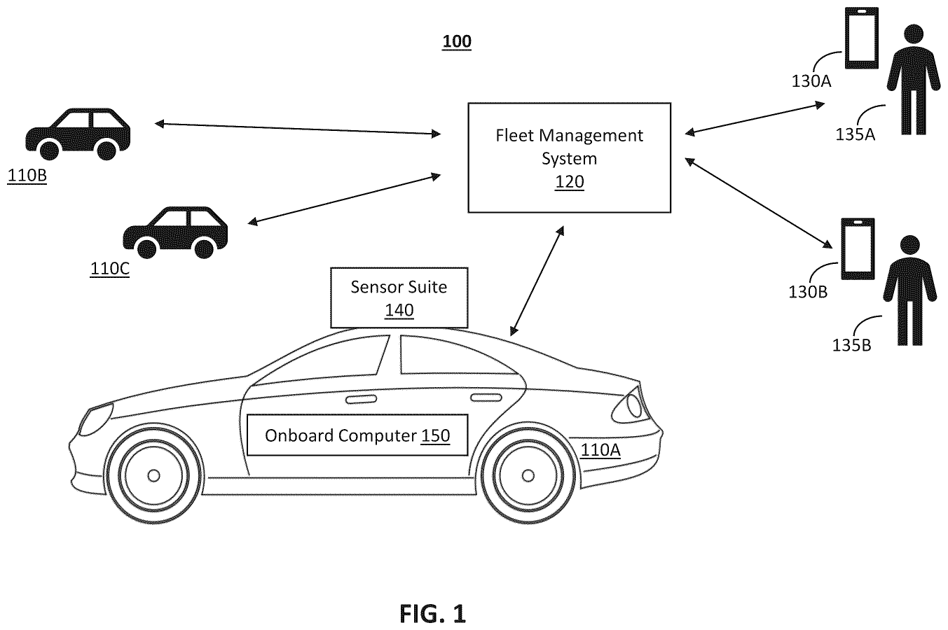

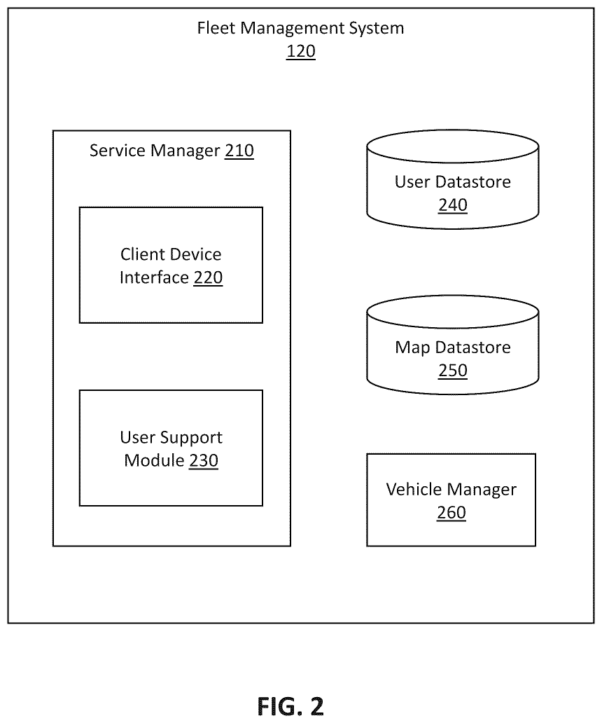

In some embodiments, the fleet management system 120 receives service requests for the AVs 110 from the client devices 130. In an example, the user 135A accesses an app executing on the client device 130A and requests a ride from a pickup location (e.g., the current location of the client device 130A) to a destination location. The client device 130A transmits the ride request to the fleet management system 120. The fleet management system 120 selects an AV 110 from the fleet of AVs 110 and dispatches the selected AV 110A to the pickup location to carry out the ride request. In some embodiments, the ride request further includes a number of passengers in the group. In some embodiments, the ride request indicates whether a user 135 is interested in a shared ride with another user traveling in the same direction or along a same portion of a route. The ride request, or settings previously entered by the user 135, may further indicate whether the user 135 is interested in interaction with another passenger. Certain aspects of the fleet management system 120 are described further in relation to FIG. 2.

A client device 130 is a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, speakers, headphones, projectors, and so on. The client device 130 may be a desktop or a laptop computer, a smartphone, a mobile telephone, a personal digital assistant (PDA), or another suitable device.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may submit service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to delivery one or more items from a location to another location), and so on. The UI may allow users 135 to provide locations (e.g., pickup location, destination location, etc.) or other information that would be needed by AVs 110 to provide services requested by the users 135.

The client device 130 may provide the user 135 an UI through which the user 135 can interact with the AV 110 that provides a ride to the user 135. The AV 110 may transmit one or more messages to the UI. The messages may be associated with one or more behaviors performed by the AV 110 for providing the ride to the user 135. The behaviors may be determined as undesirable AV behaviors for the user 135, e.g., AV behaviors that can impair the satisfaction of the user 135 with the ride. The user 135 may view the messages in the UI. The UI may also allow the user 135 to interact with the messages. In some embodiments, the UI allows the user 135 to provide a comment or rate on the AV behaviors or the ride. The UI may also allow the user 135 to modify one or more settings of the ride in light of the AV behaviors.

The client device 130 may also provide the user 135 an UI through which the user 135 can interact with the fleet management system 120. For instance, the UI enables the user to submit a request for assistance to the fleet management system 120 through a network or a telephone service (e.g., a customer service hotline). The UI can further facilitate a communication between the user 135 and an agent of the fleet management system 120 who can provide the requested assistance. The UI may further enable the user to comment on or rate the agent.

The AV 110 is preferably a fully autonomous automobile, but may additionally or alternatively be any semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

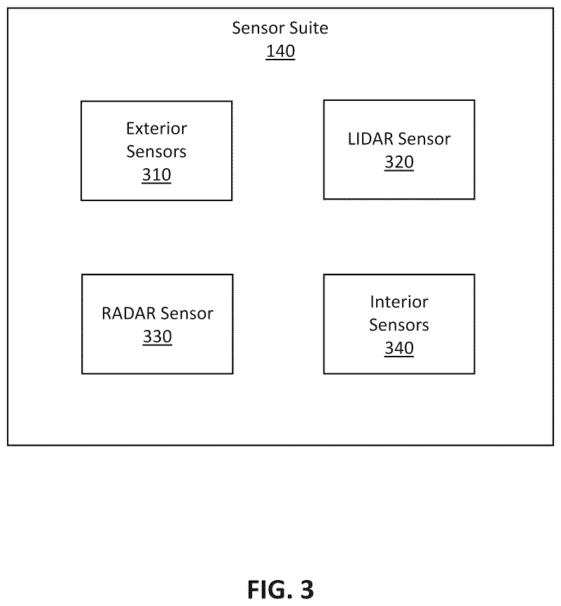

The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 3.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. The onboard computer 150 may be preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction. As another example, the onboard computer 150 may receive from the fleet management system 120 a request for sensor data to be used by the ride evaluation platform. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on.

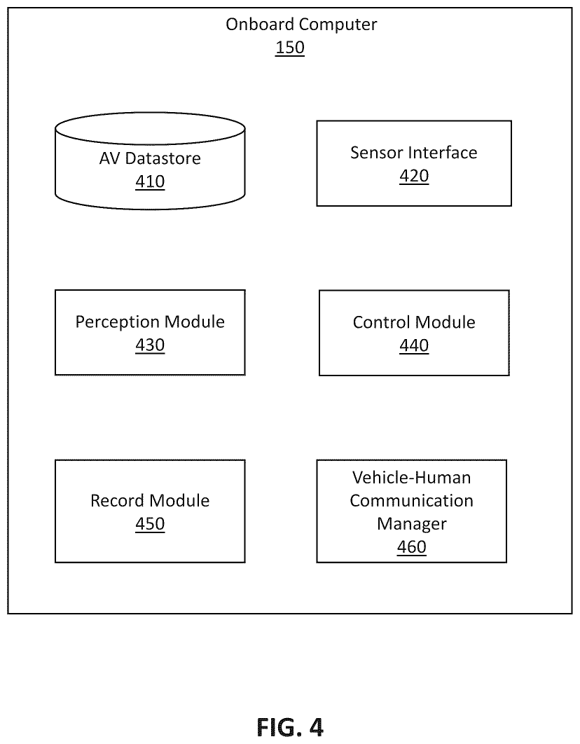

The onboard computer 150 supports a vehicle-human communication platform to communicate with users 135 about behaviors performed by AVs 110 for providing rides to the users. The onboard computer 150 may identify AV behaviors that can be of interest to the users 135, such as undesirable AV behaviors that can impair the user's ride experience. The onboard computer 150 can generate messages to acknowledge the undesirable AV behaviors and explain why the AVs 110 performed such behaviors. The messages may be presented to the user through components of the onboard computer 150 or a device (e.g., client device 130) in communication with the onboard computer 150. The onboard computer 150 can support various types of communication signals, such as text, audio, image, light, and so on. The onboard computer 150 may provide options to the users 135 to comment on or rate the undesirable AV behaviors or the rides. The onboard computer 150 may also allow the users 135 to modify the rides in light of the undesirable AV behaviors. Certain aspects of the onboard computer 150 are described further in relation to FIG. 4.

### Example Fleet Management System

FIG. 2 is a block diagram showing the fleet management system, according to some embodiments of the present disclosure. The fleet management system 120 includes a service manager 210, a user datastore 240, a map datastore 250, and a vehicle manager 260. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The service manager 210 manages services that the fleet of AVs 110 can provide. The service manager 210 includes a client device interface 220 and a user support module 230. The client device interface 220 provides interfaces to client devices, such as headsets, smartphones, tablets, computers, and so on. For example, the client device interface 220 may provide one or more apps or browser-based interfaces that can be accessed by users, such as the users 135, using client devices, such as the client devices 130. The client device interface 220 enables the users to submit requests to a ride service provided or enabled by the fleet management system 120. In particular, the client device interface 220 enables a user to submit a ride request that includes an origin (or pickup) location and a destination (or drop-off) location. The ride request may include additional information, such as a number of passengers traveling with the user, and whether or not the user is interested in a shared ride with one or more other passengers not known to the user.

The client device interface 220 can also enable users to select ride settings. The client device interface 220 can provide one or more options for the user to engage in a virtual environment, such as whether to interact with another person, whether to involve in an entertainment activity, and so on. The client device interface 220 may enable a user to opt-in to some, all, or none of the virtual activities offered by the ride service provider. The client device interface 220 may further enable the user to opt-in to certain monitoring features, e.g., to opt-in to have the interior sensors 340 obtain sensor data of the user. The client device interface 220 may explain how this data is used by the service manager 210 (e.g., for providing support to the user, etc.) and may enable users to selectively opt-in to certain monitoring features, or to opt-out of all of the monitoring features. In some embodiments, the user support platform may provide a modified version of a virtual activity if a user has opted out of some or all of the monitoring features.

The user support module 230 may receive support requests from passengers of AVs through the client device interface 220 or the onboard computer 150. The user support module 230 manages the support requests. In some embodiments, the user support module 230 maintains a queue of pending support requests, in which the pending support requests may be arranged in an order. A pending support request is a support request that has not been completed. A support request may be considered completed after the support requested by the passenger has been provided or the issue that triggered the support request has been resolved.

The user support module 230 may assign the pending support requests to agents based on the order in the queue. The agent can interact with the passenger and provide support to the passenger. An agent may be associated with a device in communication with the user support module 230. The device may be a desktop or a laptop computer, a smartphone, a mobile telephone, a PDA, or another suitable device. The user support module 230 may send information related to support requests assigned to the agent to the agent's device. The information may include the support requests and guidance on how to provide the requested support.

In some embodiments, the user support module 230 determines a state (e.g., a sentiment) of a passenger who submitted a support request and processes the support request based on the passenger's state. The user support module 230 may determine the passenger's state based on data of the passenger, data of the AV, data of one or more objects in an environment surrounding the passenger or AV, or some combination thereof. The data may include sensor data generated by the sensor suite 140 from detecting the passenger, AV, one or more objects in the environment, or some combination thereof. For instance, the user support module 230 may interface with AVs 110 (e.g., with onboard computers of the AVs 110) and receive sensor data from the AVs 110. The sensor data may be camera images, captured sound, measured temperature, other outputs from the sensor suite 140, or some combination thereof. The data may also include data retrieved by the user support module 230 from the user datastore 240 or map datastore 250. In an embodiment, the user support module 230 may provide the data to a trained model and the train model analyzes the sentiment of the passenger. The trained model may classify the passenger's sentiment. Example categories include negative (e.g., anxious, angry, etc.), neural (e.g., calm), positive (e.g., confident, happy, etc.), and so on. The trained model may also estimate a degree of the passenger's sentiment, such as an anxiety level or anger level.

The user support module 230 may assign the support request to an agent based on the passenger's state. For instance, based on a determination that the passenger is anxious, the user support module 230 may assign the support request to a currently available agent or the next available agent so that the waiting time of the passenger can be minimized. The agent, who receives the support request, can help the passenger to deal with the issue. The agent may communicate with the passenger, e.g., through an audio or video call.

The user datastore 240 stores ride information associated with users of the ride service, e.g., the users 135. In some embodiments, the user datastore 240 stores user sentiments associated with rides taken by the user 135. The user sentiments may be determined by the user support module 230. The user datastore 240 may store an origin location and a destination location for a user's current ride. The user datastore 240 may also store historical ride data for a user, including origin and destination locations, dates, and times of previous rides taken by a user. The historical data of the user may also include information associated with historical support requests made by the user during the previous rides, such as sensor data associated with the historical support requests, communications of the user with agents that serviced the historical support requests, states of the user during the communications, information of AVs 110 associated with the historical support requests, and so on. The historical data of the user may also include information associated with communications of AVs with the user for AV behaviors in historical rides taken by the user. In some cases, the user datastore 240 may further store future ride data, e.g., origin and destination locations, dates, and times of planned rides that a user has scheduled with the ride service provided by the AVs 110 and fleet management system 120. Some or all of the data of a user in the user datastore 240 may be received through the client device interface 220, an onboard computer (e.g., the onboard computer 150), a sensor suite of AVs 110 (e.g., the sensor suite 140), a third-party system associated with the user and the fleet management system 120, or other systems or devices.

In some embodiments, the user datastore 240 also stores data indicating user preferences associated with rides in AVs. The fleet management system 120 may include one or more learning modules (not shown in FIG. 2) to learn user interests based on user data. For example, a learning module may compare locations in the user datastore 240 with map datastore 250 to identify places the user has visited or plans to visit. For example, the learning module may compare an origin or destination address for a user in the user datastore 240 to an entry in the map datastore 250 that describes a building at that address. The map datastore 250 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 240. As another example, a learning module may learn user tolerance or preference for AV behaviors, e.g., based on information associated with communications of AVs with the user for AV behaviors in historical rides taken by the user. The learning module may learn that the user has a high tolerance for an AV behavior based on information indicating that the user had no bad feelings for the AV behavior undesirable in one or more previous rides. Similarly, the learning module may learn that the user has a low tolerance for a type of AV behavior based on information indicating that the user had negative sentiments towards the AV behavior in one or more previous rides.

The map datastore 250 stores a detailed map of environments through which the AVs 110 may travel. The map datastore 250 includes data describing roadways, such as e.g., locations of roadways, connections between roadways, roadway names, speed limits, traffic flow regulations, toll information, etc. The map datastore 250 may further include data describing buildings (e.g., locations of buildings, building geometry, building types), and data describing other objects (e.g., location, geometry, object type) that may be in the environments of AV 110. The map datastore 250 may also include data describing other features, such as bike lanes, sidewalks, crosswalks, traffic lights, parking lots, signs, billboards, etc.

Some of the map datastore 250 may be gathered by the fleet of AVs 110. For example, images obtained by the exterior sensors 310 of the AVs 110 may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 250. In some embodiments, certain feature data (e.g., seasonal data, such as Christmas decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map datastore 250.

The vehicle manager 260 manages and communicates with the fleet of AVs 110. The vehicle manager 260 assigns the AVs 110 to various tasks and directs the movements of the AVs 110 in the fleet. The vehicle manager 260 includes a vehicle manager 260 and an AV 110 interface 290. In some embodiments, the vehicle manager 260 includes additional functionalities not specifically shown in FIG. 2. For example, the vehicle manager 260 instructs AVs 110 to drive to other locations while not servicing a user, e.g., to improve geographic distribution of the fleet, to anticipate demand at particular locations, etc. The vehicle manager 260 may also instruct AVs 110 to return to an AV 110 facility for fueling, inspection, maintenance, or storage.

In some embodiments, the vehicle manager 260 selects AVs from the fleet to perform various tasks and instructs the AVs to perform the tasks. For example, the vehicle manager 260 receives a ride request from the client device interface 220. The vehicle manager 260 selects an AV 110 to service the ride request based on the information provided in the ride request, e.g., the origin and destination locations. If multiple AVs 110 in the AV 110 fleet are suitable for servicing the ride request, the vehicle manager 260 may match users for shared rides based on an expected compatibility. For example, the vehicle manager 260 may match users with similar user interests, e.g., as indicated by the user datastore 240. In some embodiments, the vehicle manager 260 may match users for shared rides based on previously-observed compatibility or incompatibility when the users had previously shared a ride.

The vehicle manager 260 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle manager 260 may select AVs for service in a manner that optimizes one or more additional factors, including fleet distribution, fleet utilization, and energy consumption. The vehicle manager 260 may interface with one or more predictive algorithms that project future service requests and/or vehicle use, and select vehicles for services based on the projections.

The vehicle manager 260 transmits instructions dispatching the selected AVs. In particular, the vehicle manager 260 instructs a selected AV 110 to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 260 may dispatch the same AV 110 to pick up additional users at their pickup locations, e.g., the AV 110 may simultaneously provide rides to three, four, or more users. The vehicle manager 260 further instructs the AV 110 to drive autonomously to the respective destination locations of the users.

### Example Sensor Suite

FIG. 3 is a block diagram showing the sensor suite 140, according to some embodiments of the present disclosure. The sensor suite 140 may be an onboard sensor suite of an AV, e.g., AV 110 in FIG. 1. The sensor suite 140 includes exterior sensors 310, a LIDAR sensor 320, a RADAR sensor 330, and interior sensors 340. The sensor suite 140 may include any number of the types of sensors shown in FIG. 3, e.g., one or more LIDAR sensors 320, one or more RADAR sensors 330, etc. The sensor suite 140 may have more types of sensors than those shown in FIG. 3, such as the sensors described with respect to FIG. 1. In other embodiments, the sensor suite 140 may not include one or more of the sensors shown in FIG. 3.

The exterior sensors 310 may detect objects in an environment around the AV. The environment may include a scene in which the AV operates. Example objects include objects related to weather (e.g., fog, rain, snow, haze, etc.), persons, buildings, traffic lights, traffic signs, vehicles, street signs, trees, plants, animals, or other types of objects that may be present in the environment around the AV. In some embodiments, the exterior sensors 310 include exterior cameras having different views, e.g., a front-facing camera, a back-facing camera, and side-facing cameras. One or more exterior sensors 310 may be implemented using a high-resolution imager with a fixed mounting and field of view. One or more exterior sensors 310 may have adjustable field of views and/or adjustable zooms. In some embodiments, the exterior sensors 310 may operate continually during operation of the AV. In an example embodiment, the exterior sensors 310 capture sensor data (e.g., images, etc.) of a scene in which the AV drives. In other embodiment, the exterior sensors 310 may operate in accordance with an instruction from the onboard computer 150 or an external system, such as the vehicle manager 260 of the fleet management system 120. Some of all of the exterior sensors 310 may capture sensor data of one or more objects in an environment surrounding the AV based on the instruction.

The LIDAR sensor 320 may measure distances to objects in the vicinity of the AV using reflected laser light. The LIDAR sensor 320 may be a scanning LIDAR that provides a point cloud of the region scanned. The LIDAR sensor 320 may have a fixed field of view or a dynamically configurable field of view. The LIDAR sensor 320 may produce a point cloud that describes, among other things, distances to various objects in the environment of the AV.

The RADAR sensor 330 may measure ranges and speeds of objects in the vicinity of the AV using reflected radio waves. The RADAR sensor 330 may be implemented using a scanning RADAR with a fixed field of view or a dynamically configurable field of view. The RADAR sensor 330 may include one or more articulating RADAR sensors, long-range RADAR sensors, short-range RADAR sensors, or some combination thereof.

The interior sensors 340 may detect the interior of the AV, such as objects inside the AV. Example objects inside the AV include passengers, client devices of passengers, components of the AV, items delivered by the AV, items facilitating services provided by the AV, and so on. The interior sensors 340 may include multiple interior cameras to capture different views, e.g., to capture views of an object inside the AV. The interior sensors 340 may be implemented with a fixed mounting and fixed field of view, or the interior sensors 340 may have adjustable field of views and/or adjustable zooms, e.g., to focus on one or more interior features of the AV. The interior sensors 340 may transmit sensor data to a perception module (such as the perception module 430 described below in conjunction with FIG. 4), which can use the sensor data to classify a feature and/or to determine a status of a feature.

In some embodiments, the interior sensors 340 include one or more input sensors that allow passengers to provide input. For instance, a passenger may use an input sensor to provide feedback on AV behaviors during the ride. The input sensors may include touch screen, microphone, keyboard, mouse, or other types of input devices. In an example, the interior sensors 340 include a touch screen that is controlled by the onboard computer 150. The onboard computer 150 may present messages on the touch screen and receive interaction of the passenger with the messages through the touch screen. A message may include information of one or more undesirable AV behaviors in the ride. In some embodiments, some or all of the interior sensors 340 may operate continually during operation of the AV. In other embodiment, some or all of the interior sensors 340 may operate in accordance with an instruction from the onboard computer 150 or an external system, such as the fleet management system 120.

### Example Onboard Computer

FIG. 4 is a block diagram showing the onboard computer 150 according to some embodiments of the present disclosure. The onboard computer 150 may control an AV, e.g., AV 110 in FIG. 1. As shown in FIG. 4, the onboard computer 150 includes an AV datastore 410, a sensor interface 420, a perception module 430, a control module 440, and a record module 450, and a vehicle-human communication manager 460. In alternative configurations, fewer, different and/or additional components may be included in the onboard computer 150. For example, components and modules for conducting route planning, controlling movements of the AV, and other vehicle functions are not shown in FIG. 4. Further, functionality attributed to one component of the onboard computer 150 may be accomplished by a different component included in the onboard computer 150 or a different system, such as the fleet management system 120.

The AV datastore 410 stores data associated with operations of the AV. The AV datastore 410 may store one or more operation records of the AV. An operation record is a record of an operation of the AV, e.g., an operation for providing a ride service. The operation may be a currently performed operation or a previously performed operation (“previous operation” or “historical operation”). The operation record may include information indicating operational behaviors of the AV during the operation. The operational behaviors may include sensor detection, movement, stop, battery charging, calibration, maintenance, communication with the fleet management system 120, communication with assistance agent, communication with user, communication with another AV, and so on. The operations record may also include data used, received, or captured by the AV during the operation, such as map data, instructions from the fleet management system 120, sensor data captured by the AV's sensor suite, and so on. In some embodiments, the AV datastore 410 stores a detailed map that includes a current environment of the AV. The AV datastore 410 may store data in the map datastore 250. In some embodiments, the AV datastore 410 stores a subset of the map datastore 250, e.g., map data for a city or region in which the AV is located.

The data in the AV datastore 410 may include data generated by the AV itself. The data may include sensor data capturing one or more environments where the AV operates, e.g., operates to provide services. The sensor data may be from the sensor suite 140 of the AV. The data in the AV datastore 410 may also include perception data that identifies one or more environmental conditions. The perfection data may be from the perception module 430 of the onboard computer 150 of the AV. The data may also include external data, e.g., data from other AVs or systems. For example, the data in the AV datastore 410 may include data (e.g., sensor data, perception, etc.) from one or more other AVs that capture one or more environments where the other AVs operate. As another example, the data in the AV datastore 410 may include data from the fleet management system 120, e.g., data about environmental conditions, instructions (e.g., operational plans) from the vehicle manager 260, etc. In yet another example, the data in the AV datastore 410 may include data from one or more third-party systems that provide information of environments where the AV operates. The AV may be in communication with the one or more third-party systems, e.g., through a network.

The sensor interface 420 interfaces with the sensors in the sensor suite 140. The sensor interface 420 may request data from the sensor suite 140, e.g., by requesting that a sensor capture data in a particular direction or at a particular time. For example, the sensor interface 420 instructs the sensor suite 140 to capture sensor data of an environment surrounding the AV, e.g., by sending a request for sensor data to the sensor suite 140. In some embodiments, the request for sensor data may specify which sensor(s) in the sensor suite 140 to provide the sensor data, and the sensor interface 420 may request the sensor(s) to capture data. The request may further provide one or more settings of a sensor, such as orientation, resolution, accuracy, focal length, and so on. The sensor interface 420 can request the sensor to capture data in accordance with the one or more settings.

A request for sensor data may be a request for real-time sensor data, and the sensor interface 420 can instruct the sensor suite 140 to immediately capture the sensor data and to immediately send the sensor data to the sensor interface 420. The sensor interface 420 is configured to receive data captured by sensors of the sensor suite 140, including data from exterior sensors mounted to the outside of the AV, and data from interior sensors mounted in the passenger compartment of the AV. The sensor interface 420 may have subcomponents for interfacing with individual sensors or groups of sensors of the sensor suite 140, such as a camera interface, a LIDAR interface, a RADAR interface, a microphone interface, etc.

The perception module 430 identifies objects and/or other features captured by the sensors of the AV. The perception module 430 may identify objects inside the AV based on sensor data captured by one or more interior sensors (e.g., the interior sensors 340). For instance, the perception module 430 may identify one or more passengers in the AV. In some embodiments, the perception module 430 identifies objects in the environment of the AV and captured by one or more sensors (e.g., the exterior sensors 310, LIDAR sensor 320, RADAR sensor 330, etc.). As another example, the perception module 430 determines one or more environmental conditions based on sensor data from one or more sensors (e.g., the exterior sensors 310, LIDAR sensor 320, RADAR sensor 330, etc.).

The perception module 430 may include one or more classifiers trained using machine learning to identify particular objects. For example, a multi-class classifier may be used to classify each object in the AV or in the environment of the AV as one of a set of potential objects, e.g., a passenger, a vehicle, a pedestrian, or a cyclist. As another example, a passenger classifier recognizes passengers in the AV, a pedestrian classifier recognizes pedestrians in the environment of the AV, a vehicle classifier recognizes vehicles in the environment of the AV, etc. The perception module 430 may identify facial expressions of people, such as passengers, e.g., based on data from interior cameras. The perception module 430 may identify travel speeds of identified objects based on data from the RADAR sensor 330, e.g., speeds at which other vehicles, pedestrians, or birds are traveling. As another example, the perception module 43—may identify distances to identified objects based on data (e.g., a captured point cloud) from the LIDAR sensor 320, e.g., a distance to a particular vehicle, building, or other feature identified by the perception module 430. The perception module 430 may also identify other features or characteristics of objects in the environment of the AV based on image data or other sensor data, e.g., colors (e.g., the colors of Christmas lights), sizes (e.g., heights of people or buildings in the environment), makes and models of vehicles, pictures and/or words on billboards, etc.

In some embodiments, the perception module 430 fuses data from one or more interior sensors 340 with data from exterior sensors (e.g., exterior sensors 310) and/or AV datastore 410 to identify environmental objects that one or more users are looking at. The perception module 430 determines, based on an image of a user, a direction in which the user is looking, e.g., a vector extending from the user and out of the AV in a particular direction. The perception module 430 compares this vector to data describing features in the environment of the AV, including the features' relative location to the AV (e.g., based on real-time data from exterior sensors and/or the AV's real-time location) to identify a feature in the environment that the user is looking at.

While a single perception module 430 is shown in FIG. 4, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 440 controls operations of the AV, e.g., based on information from the sensor interface 420 or the perception module 430. In some embodiments, the control module 440 controls operation of the AV by using a trained model, such as a trained neural network. The control module 440 may provide input data to the control model, and the control model outputs operation parameters for the AV. The input data may include sensor data from the sensor interface 420 (which may indicate a current state of the AV), objects identified by the perception module 430, or both. The operation parameters are parameters indicating operation to be performed by the AV. The operation of the AV may include perception, prediction, planning, localization, motion, navigation, other types of operation, or some combination thereof.

The control module 440 may provide instructions to various components of the AV based on the output of the control model, and these components of the AV will operate in accordance with the instructions. In an example where the output of the control model indicates that a change of traveling speed of the AV is required given a prediction of traffic condition, the control module 440 may instruct the motor of the AV to change the traveling speed of the AV. In another example where the output of the control model indicates a need to detect characteristics of an object in the environment around the AV (e.g., detect a speed limit), the control module 440 may instruct the sensor suite 140 to capture an image of the speed limit sign with sufficient resolution to read the speed limit and instruct the perception module 430 to identify the speed limit in the image.

The record module 450 generates operation records of the AV and stores the operations records in the AV datastore 410. The record module 450 may generate an operation record in accordance with an instruction from the fleet management system 120, e.g., the vehicle manager 260. The instruction may specify data to be included in the operation record. The record module 450 may determine one or more timestamps for an operation record. In an example of an operation record for a ride service, the record module 450 may generate timestamps indicating the time when the ride service starts, the time when the ride service ends, times of specific AV behaviors associated with the ride service, and so on. The record module 450 can transmit the operation record to the fleet management system 120.

The vehicle-human communication manager 460 facilitates communications of the AV with humans, such as people who are involved in operations of the AV. People involved in operations of the AV may include passengers of the AV, users 135 of the AV or of the fleet management system 120 (e.g., people who requested services to be provided by the AV), drivers of other vehicles environments where the AV operates, law enforcement personnel (e.g., police officers), pedestrians in environments where the AV operates, and so on. In some embodiments, the vehicle-human communication manager 460 may initiate a communication with a person for an AV behavior that is performed by the AV and is classified by the vehicle-human communication manager 460 as an undesirable AV behavior for the person. An undesirable AV behavior is an AV behavior that can cause a negative sentiment of the person towards the driverless operation of the AV. The negative sentiment may be surprised, confused, discomfort, anxious, unsecure, other negative sentiments, or some combination thereof. In embodiments where the person is a passenger receiving a ride provided by the AV, the undesirable AV behavior can impair the person's experience of having the driverless ride and may even cause dissatisfaction of the user with the ride.

The vehicle-human communication manager 460 can generate one or more messages to communicate with the person for the undesirable AV behavior. A message may include information that can minimize or even eliminate the negative sentiment of the person ride. In an example, a message may acknowledge the undesirable AV behavior and explain the reason why the undesirable AV behavior was performed, which can address the person's confusion about the undesirable AV behavior (if any) and promote the person's trust in the operation of the AV. In another example, a message may query the state of the person and offer help that the person may need, which can make the person feel more comfortable or safer.

In some embodiments (e.g., embodiments where the person is a passenger of the AV), a message may also include one or more options (e.g., one or more UI elements) for the person to rate or comment on the undesirable AV behavior or on the ride. A message may also include one or more options for the user to modify one or more settings of the ride, such as the destination, the route, and so on. In other embodiments (e.g., embodiment where the person is outside the AV), a message may include information regarding how to interact with the AV safely or efficiently. For example, the message may include information for a policy officer to contact the remote support of the AV. As another example, the message may include an instruction for a pedestrian or the driver of another vehicle to avoid a potential accident with the AV. Such vehicle-human communications can improve the performance (e.g., safety, passenger satisfaction, etc.) of the AV and build up trust and confidence of people in driverless operations of the AV.

In some embodiments, the communications between the AV and people are personalized. In some embodiments, the vehicle-human communication manager 460 may apply information of a person to determine whether to have a communication with the person, e.g., by determining whether the AV behavior was undesirable by the person. Different people may have different sentiments towards the same AV behavior given their personal tolerances or preferences, so an undesirable AV behavior for a person may be an expected AV behavior for another person. The vehicle-human communication manager 460 may also apply information of the person to generate messages in the communication. The information of the person may be data from one or more sensors of the AV that have captured the person, information provided by the person (e.g., information provided by a user 135 to the AV or to the fleet management system 120), historical data of the person (e.g., data associated with historical rides taken by the person), and so on.

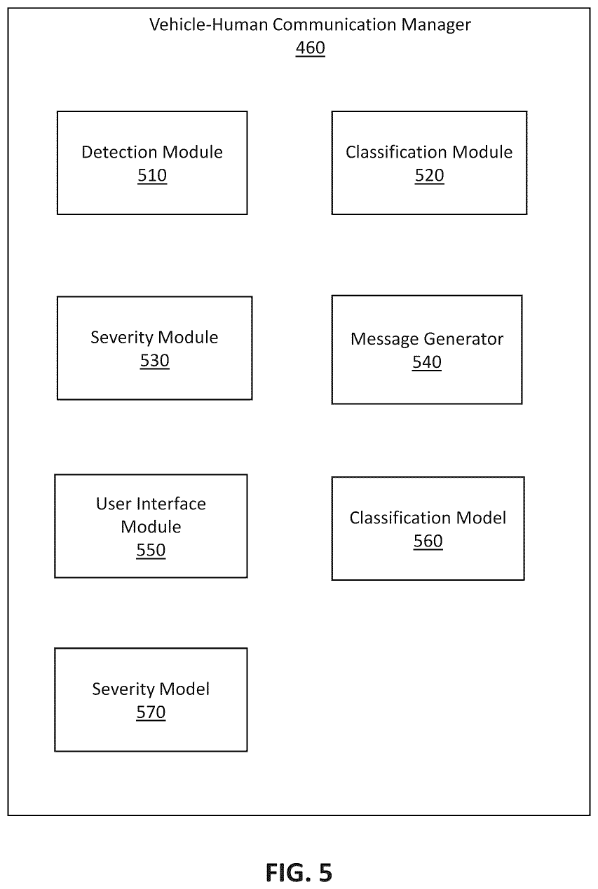

In some embodiments, the communications between the AV and people are dynamic. The vehicle-human communication manager 460 can facilitate a conversation with the user. The vehicle-human communication manager 460 may receive a user response to a message and generate one or more other messages based on the user response. Certain aspects of the vehicle-human communication manager 460 are provided below in conjunction with FIG. 5.

### Example Vehicle-Human Communication Manager

FIG. 5 is a block diagram showing the vehicle-human communication manager 460, according to some embodiments of the present disclosure. The vehicle-human communication manager 460 includes a detection module 510, a classification module 520, a severity module 530, a message generator 540, a UI module 550, a classification model 560, and a severity model 570. In alternative configurations, different and/or additional components may be included in the vehicle-human communication manager 460. For example, the classification model 560 and the severity model 570 may be a single trained model. As another example, the vehicle-human communication manager 460 may not include the classification model 560 or the severity model 570. Further, functionality attributed to one component of the vehicle-human communication manager 460 may be accomplished by a different component included in the vehicle-human communication manager 460, a different component included in the onboard computer 150, or a different system (such as the fleet management system 120).

The detection module 510 detects operational behaviors of AVs performed in driverless operations of the AVs. A drivenness operation of an AV may be for providing a ride to a person and can influence the quality of the ride service, such as safety, passenger comfort, other quality metrics, or some combination thereof. AV behaviors associated with a ride may include AV behaviors before the ride (e.g., before the user is picked up), during the ride (e.g., while the user is in the AV), after the ride (e.g., after the user is dropped off), or some combination thereof. Example AV behaviors include movement behaviors (such as driving, changing speed, turning, stopping, speeding, cornering, tailgating, swerving, etc.), signal behavior (e.g., light, honk, beep, etc.), passenger compartment behavior (e.g., air-conditioning, passenger seat adjustment, etc.), other AV behaviors, or some combination thereof.

The detection module 510 may use sensor data generated by one or more sensors (e.g., sensors in the sensor suite 140) of an AV to detect AV behaviors. In some embodiments, the detection module 510 may instruct the sensor interface 420 to obtain the sensor data, e.g., by sending a request for the sensor data to the sensor suite 140. The detection module 510 may also detect AV behaviors of an AV by referring to one or more operation records of the AV, e.g., operation records created by the record module 450 or stored in the AV datastore 410. Additionally or alternatively, the detection module 510 may communicate with the control module 440 to obtain information about AV behaviors. For instance, the detection module 510 may receive information about an AV behavior from the control module 440 after the control module 440 determines that the AV is to perform the AV behavior for the ride service.

The classification module 520 classifies AV behaviors detected by the detection module 510. For instance, the classification module 520 determines whether an AV behavior is an undesirable AV behavior for a person. In some embodiments, the classification module 520 may determine whether a detected AV behavior falls into the category of undesirable AV behaviors based on a reference AV behavior. The reference AV behavior may be an expected AV behavior (e.g., a behavior instructed by the vehicle manager 260), a standard AV behavior (e.g., a behavior that AVs would normally perform in same or similar situations), a safety-driven AV behavior (e.g., a behavior that AVs should take or avoid for safety reasons), a comfort-driver AV behavior (e.g., a behavior that AVs should take or avoid for comfort of passengers), and so on. The classification module 520 may place the detected AV behavior into the category in response to a determination that the detected AV behavior does not match the reference behavior.

In an embodiment, the classification module 520 may determine that the detected AV behavior does not match the reference behavior based on that the behavior is different from the reference behavior, that a parameter of the AV behavior is different from a corresponding parameter of the reference AV behavior, or that a difference between the parameter and the corresponding parameter is beyond a threshold. Example parameters may be speed, direction, position/location, distance, time, acceleration, deceleration, acceleration rate, deceleration rate, setting of an AV component, and so on. In an example, the classification module 520 may determine that a brake is an undesirable AV behavior as the deceleration is greater than a deceleration limit.

The classification module 520 may also apply information of the person (“personal information”) to classify AV behaviors. The personal information may include information that can indicate one or more sentiments of the person towards one or more AV behaviors. In an example, the personal information may include data captured by one or more sensors of the AV or perception of the person by the perception module 430. For instance, the one or more sensors or the perception module 430 may capture a facial expression, gesture, or speech of the person, which may indicate the person's sentiment or state. In another example, the personal information may include information provided by the person, such as information provided by a user 135 for requesting a ride, information expressing the person's preference, and so on. In another example, the personal information may include information associated with one or more historical rides received by the person, such as the person's sentiment towards AV behaviors during the historical rides, and so on. The person may be a user of the fleet management system 120. The information associated with one or more historical rides received by the person may be stored in the user datastore 240 as the historical data of the user. In another example, the personal information may include information of one or more other people who are determined to have similar tolerance or preference as the person. The classification module 520 may receive the personal information from the sensor suite of the AV, the onboard computer of the AV, the fleet management system 120, a client device associated with the user, other sources, or some combination thereof. In embodiments where the classification module 520 uses a reference AV behavior to classify the detected AV behavior, the classification module 520 may determine the reference AV behavior based on the personal information.

In some embodiments, the classification module 520 may use the classification model 560 to classify detected AV behaviors. The classification model 560 is a model trained with machine learning techniques. The classification module 520 may input information of the detected AV behavior and information of the person into the classification model 560. The classification model 560 may output a determination whether the detected AV behavior is an undesired AV behavior for the person.

The classification module 520 may include or be associated with a training module that trains the classification model 560. As part of the generation of the classification model 560, a training set may be formed. The training set may include training samples and ground-truth labels of the training samples. A training sample may include a set of data associated with an AV behavior associated with a ride service and information of a user receiving the ride service. The training sample may have one or more ground-truth labels, e.g., a verified or known classification of the AV behavior being an expected (or unexpected) AV behavior for the user. A ground-truth label may be an acknowledgment of the user that the AV behavior was expected or unexpected. The training set may include one or more positive training samples and one or more negative training samples. A positive training sample has a ground-truth label indicating that the AV behavior is an undesirable AV behavior. A negative training sample has a ground-truth label indicating that the AV behavior is not an undesirable AV behavior. Features may be extracted from the training set, the features being variables deemed potentially relevant to the classification of AV behaviors. An ordered list of the features may be a feature vector.

In some embodiments, the training module may apply dimensionality reduction (e.g., via linear discriminant analysis (LDA), principal component analysis (PCA), or the like) to reduce the amount of data in the feature vectors to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The classification module 520 or the training module may continuously train the classification model 560. For instance, the classification module 520 may receive from a response on an AV behavior, e.g., through a UI facilitated by the UI module 550. The feedback expresses a sentiment of the person towards the AV behavior. The classification module 520 or the training module may form a new training sample, which includes the information of the AV behavior and the information of the person. The classification module 520 or the training module may also generate a ground-truth classification of the AV behavior by determining whether the person thought that the AV behavior was undesirable or not based on the person's feedback. The classification module 520 or the training module may use the new training sample and the ground-truth classification to further train the classification model 560. In embodiments where the person thinks that the AV behavior is undesirable (e.g., the person expresses that he or she was bothered by the AV behavior), the new training sample may be used as a positive training sample. In embodiments where the person thinks that the AV behavior is not undesirable (e.g., the person expresses that he or she was fine with the AV behavior), the new training sample may be used as a negative training sample.

The severity module 530 evaluates severity of undesirable AV behaviors. In some embodiments, the severity module 530 may determine a severity score of an undesirable AV behavior. The severity score is an estimated extent of a negative sentiment of the person towards the undesirable AV behavior. In some embodiments, the severity module 530 may determine the severity score based on information of the undesirable AV behavior and information of the user. The severity score may be specific to the person. Severity scores for different users may be different for the same AV behavior. The severity module 530 may input the information of the undesirable AV behavior and information of the person into the severity model 570. The severity model 570 may output the severity score.

The severity module 530 may include or be associated with a training module that trains the severity model 570. As part of the generation of the severity model 570, a training set may be formed. The training set may include training samples and ground-truth labels of the training samples. A training sample may include a set of data associated with an undesirable AV behavior associated with a ride service and information of a person involved in the undesirable AV behavior. The training sample may have a ground-truth label, e.g., a verified or known severity score of the undesirable AV behavior. Features may be extracted from the training set, the features being variables deemed potentially relevant to the level of severity of AV behaviors. An ordered list of the features may be a feature vector.

In some embodiments, the training module may apply dimensionality reduction (e.g., via LDA, PCA, or the like) to reduce the amount of data in the feature vectors to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The severity module 530 or the training module may continuously train the severity model 570. For instance, the severity module 530 may receive feedback from the person (e.g., through a user interface facilitated by the UI module 550), which expresses the true extent of the negative sentiment of the user towards the undesirable AV behavior. The severity module 530 or the training module may form a new training sample that includes the information of the AV behavior and the information of the user. The severity module 530 or the training module may also use the person's feedback to determine a ground-truth severity score and further train the severity model 570 with the new training sample and the ground-truth severity score.

The message generator 540 generates messages that can be used to communicate with humans for undesirable AV behaviors. A message may include text, audio, image (e.g., static image, animated image, video, etc.), light, other types of communication signals, or some combination thereof. The message generator 540 may generate one or more messages for an undesirable AV behavior. The one or more messages may include information that can help with minimizing or even eliminating the negative sentiment of the person. The one or more messages can also improve the performance of the AV, e.g., by improving safety, passenger comfort, or both. In some embodiments, the information in the one or more messages may be an acknowledgment of the undesirable AV behavior, a reason why the AV performed the undesirable AV behavior (e.g., an explanation that the AV had to do a hard brake to avoid hitting another vehicle that suddenly entered the lane of the AV), a query of the person's physical or emotional state, a solution to address a problem caused by the undesirable AV behavior, other information, or some combination thereof.

In some embodiments, a message may include one or more UI elements, through which the person can respond to the message. In some embodiments, the one or more UI elements may facilitate the person to provide a response to the message. The person's response may indicate the true sentiment of the person towards the undesirable AV behavior. For instance, the response may express that the person did have a negative sentiment towards the AV behavior or that the person did not have bad feelings towards the AV behavior. The person's response may also express the extent of the person's negative sentiment towards the AV behavior. The person's response, in embodiments where the person is a passenger of the AV, may express the person's sentiment towards the ride. The message generator 540 may generate one or more other messages based on the person's response. The message generator 540 can facilitate a dynamic, unique, and personalized conversation with the person.

In some embodiments, a message may include options for the person to modify the operation of the AV. For instance, a message may allow a passenger of the AV to modify the ride. For instance, the message generator 540 may generate a message including an option for the person to change the destination of the ride, change a route of the ride, terminate the ride, and so on. The message generator 540 may include one or more optional settings of the ride (which may be different from the current settings of the ride) in the message and the person can select the one or more optional settings. The message generator 540 may determine the one or more optional settings based on the unexpected AV behavior or the reason why the unexpected AV behavior was performed. In an example where the AV unexpectedly stopped before it arrives at the destination given a road closure, the message generator 540 may determine one or more alternative routes to the person's destination and include the alternative routes in the message so that the person can select an alternative route for the ride. Alternatively, the message generator 540 may allow the person to change the destination. The message generator 540 may identify one or more alternative destinations, which may be similar as the original destination, e.g., may provide the same types of service or product. The message generator 540 may include the one or more alternative destinations to the message so that the person can select an alternative destination for the ride.

In some embodiments, the message generator 540 may generate a message for an unexpected AV behavior based on sensor data captured by the sensor suite of the AV in an environment where the AV was operating when the unexpected AV behavior was performed. The sensor suite of the AV (e.g., one or more exterior sensors of the AV) may detect one or more objects in the AV. The sensor data may include information of the one or more objects. The message may include the sensor data. In the example of the hard brake, the message may include a video captured by one or more exterior cameras of the AV, which shows that the other vehicle suddenly entered the lane of the AV. Additionally or alternatively, the message may include data generated based on the sensor data. For instance, the message may include an animation showing that a vehicle suddenly entered the lane of the AV. The animation includes a graphical representation of the other vehicle, and the graphical representation is generated based on sensor data capturing the other vehicle.

In some embodiments, the message generator 540 may generate one or more messages for an unexpected AV behavior based on the severity score of the unexpected AV behavior determined by the severity module 530. The message generator 540 may determine what signal(s) to include in the message based on the severity score. In an example, the message generator 540 may include a video in the message based on a determination that the severity score is greater than a threshold score versus text in the message based on a determination that the severity score is no greater than the threshold score. Compared with text, video can be more effective to communicate with the user, but the message generator 540 would need more computation resources to generate the message. The message generator 540 may select to consume extra computation resources for unexpected AV behavior that has a more severe impact on the user's satisfaction with the ride service. In another example, the message generator 540 may include one or more alerting signals (e.g., light, sound, etc.) in the message or generate one or more alerting messages based on a determination that the severity score is beyond a threshold score. The alerting signals or alerting messages can alert the person of the message to minimize or even eliminate the risk of the person ignoring or missing the message. The alerting signals or alerting messages can be presented to the person before, while, or after the message is being presented to the person.

In some embodiments, the message generator 540 may also generate an instruction to modify the setting(s) of one or more parts of the AV before, while, or after the message is being presented to the person. The instruction may be included in the message or be associated with the message. The modification of the setting(s) of the one or more parts may facilitate the communication of the AV with the user. For instance, the message generator 540 may generate an instruction to decrease the temperature of the air conditioner in the AV so that the temperature in the passenger compartment can be dropped. The lower temperature can help make the person more alert. In an embodiment, the message generator 540 may generate the instruction based on a determination that the severity score of the unexpected AV behavior is beyond a threshold score.

The UI module 550 facilitates one or more UIs through which the AV may communicate with humans. An UI may be supported by one or more parts of the AV, through which messages for unexpected AV behaviors can be presented to people and the people can respond to the messages. A part supporting the UI may be in the passenger compartment of the AV or attached to the exterior of the AV. Example parts include display screen (e.g., touch screen, etc.), speaker, microphone, light, and so on. The UI may also include buttons, switches, or other devices that the person can user to perceive the message or to respond to the message. In some embodiments (such as embodiments where a message includes one or more UI elements), the UI module 550 can facilitate the UI elements so that the person can interact with the message.

### Example AV Passenger Compartment

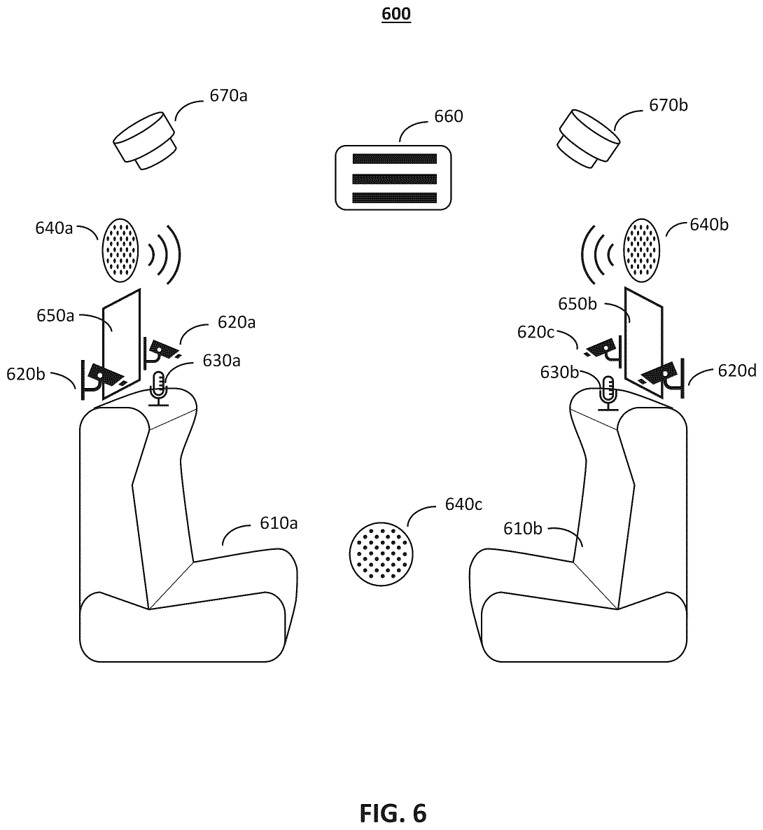

FIG. 6 is a diagram illustrating a passenger compartment 600 of an AV according to some embodiments of the present disclosure. The AV may be an embodiment of the AV 110. The passenger compartment 600 includes parts that can facilitate the AV to communicate with passengers of the AV. One or more parts in the passenger compartment 600 may be used to present messages generated by the AV for undesirable AV behaviors. One or more other parts in the passenger compartment 600 may be used to detect or classify undesirable AV behavior or to generate the messages, e.g., by capturing sentiments of passengers. The parts shown in FIG. 6 are illustrated as examples. In other embodiments, the passenger compartment 600 may include fewer, more, or different parts that can facilitate communications of the AV with people.

As shown in FIG. 6, the passenger compartment 600 includes two rows of seats 610a and 610b that are arranged facing each other. Each row of seats 610a and 610b can seat a fixed number of passengers, e.g., two passengers or three passengers. The passenger compartment 600 is further equipped with interior cameras 620a, 620b, 620c, and 620d, which are examples of the interior sensors 340 described with respect to FIG. 3. In this example, each row of seats 610a and 610b has two interior cameras above it and facing the opposite row of seats. For example, if the row of seats 610a is configured to seat two passengers, the interior camera 620c is positioned to capture images of a passenger sitting on the left side of the row of seats 610a, and the interior camera 620d is positioned to capture images of a passenger sitting on the right side of the row of seats 610a. In some embodiments, a single interior camera 620 can capture a view of multiple passenger seats. The passenger compartment 600 further includes microphones 630a and 630b for capturing audio, e.g., voices of users in the passenger compartment 600. In some embodiments, the microphones 630 are integrated into the interior cameras 620.

The passenger compartment 600 further includes various output devices, such as speakers 640a, 640b, and 640c, and display screens 650a and 650b. The speakers 640a, 640b, and 640c provide audio output to the passenger compartment 600. The speakers 640 may be located at different points throughout the passenger compartment 600, and the speakers 640 may be individually or jointly controlled. The display screens 650 may be a touch screen. In this example, a display screen 650 is above each of the rows of seats 610a and 610b and viewable to the row of seats positioned opposite. For example, passengers seated in the row of seats 610a can view the display screen 650b. A display screen 650 may be equipped to receive user input, e.g., as a touchscreen, or through one or more buttons or other user input devices arranged proximate to each display screen 650 or elsewhere in the passenger compartment 600.

To determine whether a seat has a seated passenger, the onboard computer 150 may perform an image detection algorithm on images captured by each of the interior cameras 620. As another example, the passenger compartment 600 includes weight sensors incorporated into the passenger seats that transmit weight measurements to the onboard computer 150, and the onboard computer 150 determines based on the weight measurements whether each seat has a seated passenger. In other embodiments, the onboard computer 150 uses one or more other interior sensors (e.g., LIDAR, RADAR, thermal imaging, etc.) or a combination of sensors to identify the locations of passengers seated in the AV 110. In some embodiments, the onboard computer 150 instructs interior cameras 620 directed at seats that have seated passengers to capture images, while other interior cameras 620 do not capture images.

In alternate configurations, the passenger compartment 600 has rows of seats in different configurations (e.g., two rows facing the same direction), more rows of seats, fewer rows of seats, one or more individual seats (e.g., bucket seats), or some combination of seats (e.g., one bench seat and two bucket seats). The arrangement of the interior cameras 620, microphones 630, speakers 640, and display screens 650 may be different from the arrangement shown in FIG. 6 based on the arrangement of the seats. For example, the passenger compartment 600 includes one or more display screens that are visible to each of the passenger seats, and video cameras that are positioned to capture a view of each passenger seat.

### Example AV-Human Communication

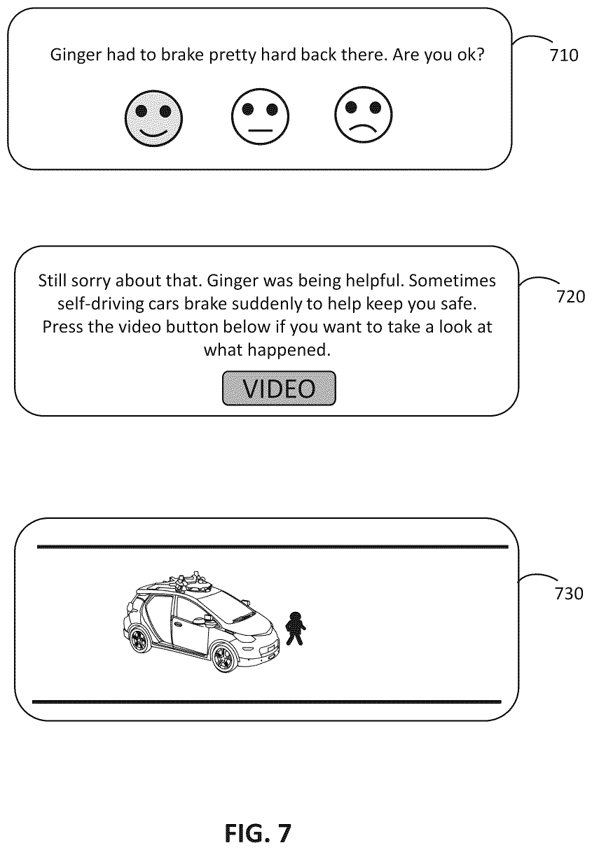

FIG. 7 illustrates an example conversation of an AV with a passenger, according to some embodiments of the present disclosure. FIG. 7 shows three messages 710, 720, and 730 that are presented to the passenger by the AV. The messages 710, 720, and 730 may be presented on a touch screen of an onboard computer (e.g., the onboard computer 150) of the AV or a client device (e.g., the client device 130) of the passenger. An embodiment of the touch screen may be the display screen 650a or 650b in FIG. 6. In other embodiments, the messages 710, 720, and 730 may be presented by using other parts of the AV or other devices.

The messages 710, 720, and 730 may be generated by the vehicle-human communication manager 460. In the embodiments of FIG. 7, the messages 710, 720, and 730 are presented sequentially. The message 710 is presented first. The message 710 may be triggered by a detection of an undesirable AV behavior. For the purpose of illustration, the undesirable AV behavior is a hard brake. The vehicle-human communication manager 460 may detect the hard brake based on sensor data from one or more sensors of the AV, an operation record of the AV, the control module 440 of the AV, etc. The vehicle-human communication manager 460 classifies the hard brake as an undesirable AV behavior by determining that the person would have a negative sentiment (e.g., discomfortable, confused, upset, etc.) towards the hard brake. The vehicle-human communication manager 460 may make the determination based on a comparison showing that the deceleration of the hard brake is beyond a deceleration limit. The vehicle-human communication manager 460 may also apply personal information indicating the passenger's tolerance for brake to make the determination. The message 710 acknowledges the hard brake by saying that “Ginger had to brake pretty hard back there,” where Ginger is the name of the AV. The message 710 also queries the passenger's sentiment by asking whether the passenger is ok and including three emojis representing three different sentiments for the passenger to pick.

The passenger picked the happy face emoji, which shows that the passenger does not have any bad feelings towards the hard brake. The vehicle-human communication manager 460 may determine that the hard brake is not undesirable to the passenger based on the passenger's response. The vehicle-human communication manager 460 may use the hard brake as a new training sample, which may also include personal information of the passenger, to further train a model that the vehicle-human communication manager 460 used to classify the hard brake as an undesirable AV behavior.

After receiving the passenger's response to the message 710, the vehicle-human communication manager 460 generates the message 720 based on the passenger's response and provides the message 720 for display to the passenger. The message 720 includes an apology for the hard brake with an acknowledgment of the passenger's response. The message 720 also explains why the hard brake happened and offers a video showing the incident that triggered the hard brake. The message 720 includes a “VIDEO” button that the passenger may press to watch the video.

The passenger selects to watch the video and presses the button. After receiving the passenger's response to the message 720 (i.e., pressing the button), the vehicle-human communication manager 460 generates the message 730 and provides the message 730 for display to the passenger. The message 730 includes a video showing a person running into the lane of the AV suddenly, which explains why the hard brake was necessary to avoid an accident. The video may be generated based on the detection of the environment surrounding the AV by one or more sensors of the AV, e.g., the exterior sensors 310. For the purpose of illustration, FIG. 7 shows an image in the video. The image may be an image captured by an exterior camera of the AV. Even though not shown in FIG. 7, the message 730 may include an audio that can be presented to the passenger.

Even though the messages 710 and 720 include text, the message 710 or 720 may include one or more different signals. For instance, the message 710 or 720 may be audio messages and can be presented to the passenger through one or more speakers in the AV. The passenger may respond to the message 710 or 720 orally, e.g., through one or more microphones in the AV.

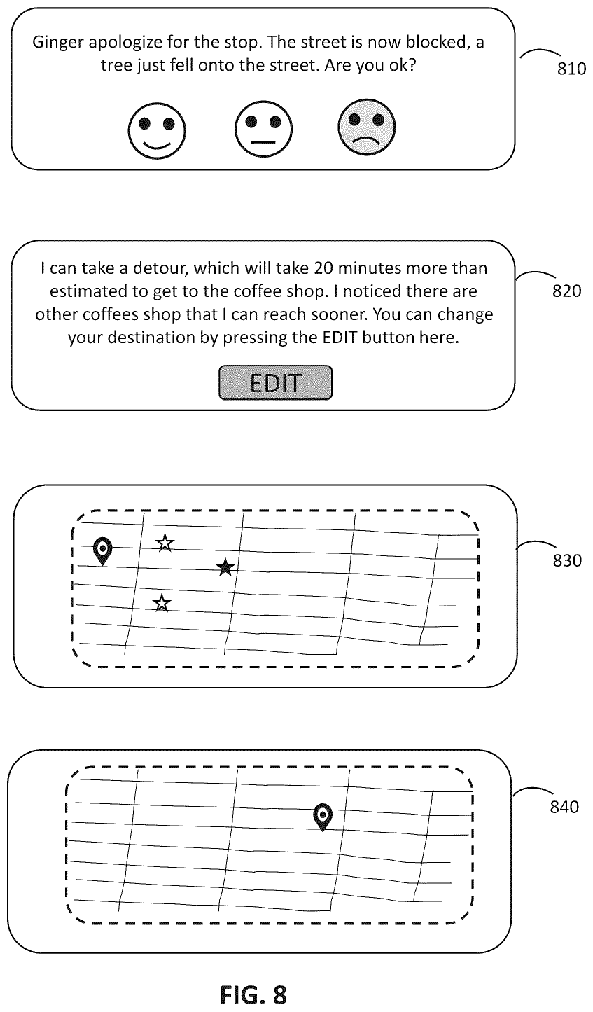

FIG. 8 illustrates another example conversation of an AV with a passenger, according to some embodiments of the present disclosure. FIG. 8 shows four messages 810, 820, 830, and 840 that are presented to the passenger by the AV. The messages 810, 820, 830, and 840 may be presented on a touch screen of an onboard computer (e.g., the onboard computer 150) of the AV or a client device (e.g., the client device 130) of the passenger. An embodiment of the touch screen may be the display screen 650a or 650b in FIG. 6. In other embodiments, the messages 810, 820, 830, and 840 may be presented by using other parts of the AV or other devices.

The messages 810, 820, 830, and 840 may be generated by the vehicle-human communication manager 460. In the embodiments of FIG. 8, the messages 810, 820, 830, and 840 are presented sequentially. The message 810 is presented first. The message 810 may be triggered by a detection of an undesirable AV behavior. For the purpose of illustration, the undesirable AV behavior is a stop. The vehicle-human communication manager 460 may detect the stop based on sensor data from one or more sensors of the AV, an operation record of the AV, the control module 440 of the AV, etc. The vehicle-human communication manager 460 classifies the stop as an undesirable AV behavior as it is unexpected by the passenger. The message 810 acknowledges the stop and apologies for the stop. The message 810 queries the passenger's sentiment by asking whether the passenger is ok and including three emojis representing three different sentiments for the passenger to pick. The message 820 also explains why the AV had to stop.

The passenger picked the sad face emoji, which shows that the passenger does have a negative sentiment towards the hard brake. The vehicle-human communication manager 460 may determine that the stop is indeed undesirable to the passenger based on the passenger's response. The vehicle-human communication manager 460 may use the stop as a new training sample, which may also include personal information of the passenger, to further train a model that the vehicle-human communication manager 460 used to classify the stop as an undesirable AV behavior.

After receiving the passenger's response to the message 810, the vehicle-human communication manager 460 generates the message 820 based on the passenger's response and provides the message 820 for display to the passenger. The message 820 includes a suggestion for changing the destination of the ride in light of the accident that caused the unexpected stop of the AV. The message 820 also provides alternative destinations to the passenger. The vehicle-human communication manager 460 may determine the alternative destinations based on the original destination of the passenger, which is a coffee shop. The vehicle-human communication manager 460 identifies alternative destinations that provide the same service and produce as the original destination. The vehicle-human communication manager 460 may also identify the alternative destinations based on their locations and the current location of the AV. In the example of FIG. 8, the vehicle-human communication manager 460 identifies other coffee shops that are close to the current location of the AV. The message 820 also includes an UI button that the passenger can use to edit the ride.

Even though the messages 810 and 820 include text, the message 810 or 820 may include one or more different signals. For instance, the message 810 or 820 may be audio messages and can be presented to the passenger through one or more speakers in the AV. The passenger may respond to the message 810 or 820 orally, e.g., through one or more microphones in the AV.

The passenger pushes the button in the message 820. In response to that, the vehicle-human communication manager 460 provides the message 830 to the passenger. The message 830 includes a map of an area including the original destination, which is represented by the pinpoint. The map also shows the alternative destinations, which are represented by the stars. The passenger selected one of the alternative destinations. The alternative destination selected by the passenger is represented by the black star, the other alternative destinations are represented by the white stars.

After the passenger selects the alternative destination, the vehicle-human communication manager 460 provides the message 840, which includes another map of the area showing the new destination of the ride. Even though not shown in FIG. 8, the message 840 may also show the route from the current location of the AV to the new destination.

### Example Method of Vehicle-Human Communication

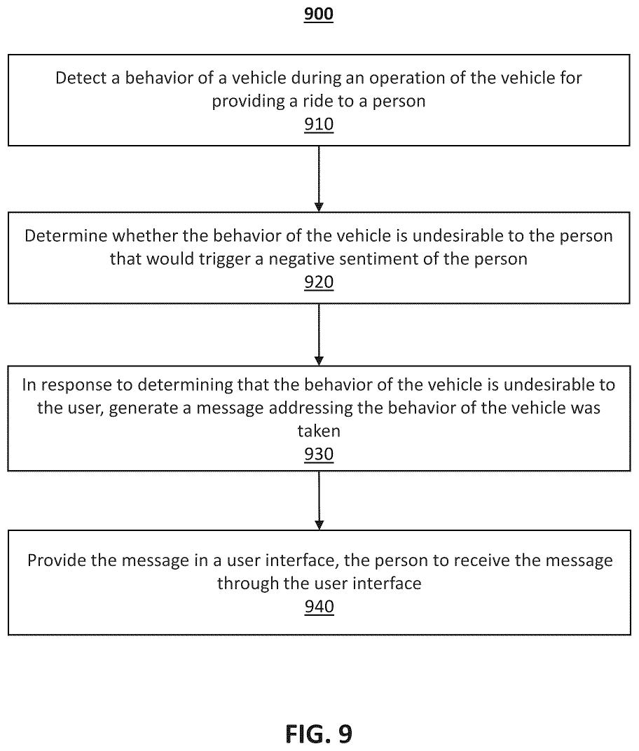

FIG. 9 is a flowchart showing a method 900 of vehicle-human communication, according to some embodiments of the present disclosure. The method 900 may be performed by the vehicle-human communication manager 460. Although the method 900 is described with reference to the flowchart illustrated in FIG. 9, many other methods of vehicle-human communication may alternatively be used. For example, the order of execution of the steps in FIG. 9 may be changed. As another example, some of the steps may be changed, eliminated, or combined.

The vehicle-human communication manager 460 detects, in 910, a behavior of a vehicle during an operation of the vehicle for providing a ride to a person. The vehicle may be an AV 110. In some embodiments, the vehicle-human communication manager 460 detects the behavior of the vehicle based on sensor data from one or more sensors of the vehicle, an operational record of the vehicle, or a control module that plans behaviors of the vehicle in the operation.

The vehicle-human communication manager 460 determines, in 920, whether the behavior of the vehicle is undesirable to the person that would trigger a negative sentiment of the person. In some embodiments, the behavior of the vehicle is a change in speed. The vehicle-human communication manager 460 determines whether a rate of the change in speed is beyond a predetermined rate limit. Based on a determination that the rate of the change in speed is beyond the predetermined rate limit, the vehicle-human communication manager 460 determines that the behavior of the vehicle is undesirable to the person. Based on a determination that the rate of the change in speed is not beyond the predetermined rate limit, the vehicle-human communication manager 460 determines that the behavior of the vehicle is not undesirable to the person.

In some embodiments, the vehicle-human communication manager 460 obtains personal information that indicates the person's sentiment towards the behavior of the vehicle and determines whether the behavior of the vehicle is undesirable to the person based on the personal information. For instance, the vehicle-human communication manager 460 inputs the personal information and information describing the behavior of the vehicle into a trained model. The trained model outputs a determination of whether the behavior of the vehicle is undesirable to the person. The personal information may include data captured by one or more sensors of the vehicle during the operation of the vehicle, information provided by the person, information about one or more historical rides received by the person, or some combination thereof.

The vehicle-human communication manager 460 may receive a response from the person on the behavior of the vehicle. The response expresses the person's sentiment towards the behavior of the vehicle. For instance, the response may indicate whether the person has any bad feelings with the behavior of the vehicle. The vehicle-human communication manager 460 may further train the trained model based on the response from the person. The response is used to generate a ground-truth label for a training sample, which includes the behavior of the vehicle and the personal information.

The vehicle-human communication manager 460 generates, in 930, a message, in response to determining that the behavior of the vehicle is undesirable to the person. The message addresses the behavior of the vehicle. For instance, the message explains a reason why the behavior of the vehicle was performed.

In some embodiments, the vehicle-human communication manager 460 determines a severity score of the behavior of the vehicle. The severity score indicates an estimated extent of the negative sentiment of the person towards the behavior of the vehicle. The vehicle-human communication manager 460 generates the message based on the severity score.

In some embodiments, the vehicle-human communication manager 460 generates one or more images of one or more objects in an environment where the vehicle was operating when the behavior of the vehicle was performed. The one or more images are generated based on sensor data from one or more sensors of the vehicle that detected the one or more objects in the environment.

The vehicle-human communication manager 460 provides, in 940, the message in a UI. The person is to receive the message through the UI. In some embodiments, the vehicle-human communication manager 460 provides an option in the message for the person to modify the ride. For instance, the person may be able to modify the destination, the route to the destination of the ride, and so on. The person may be able to modify the ride through the UI. The vehicle-human communication manager 460 may modify one or more settings of one or more parts of the vehicle to alert the person of the message.

### Select Examples

Example 1 provides a method, including detecting a behavior of a vehicle during an operation of the vehicle for providing a ride to a person; determining whether the behavior of the vehicle is undesirable to the person that would cause a negative sentiment of the person; in response to determining that the behavior of the vehicle is not undesirable to the person, generating a message addressing the behavior of the vehicle, the message comprising one or more images of one or more objects in an environment where the vehicle was operating when the behavior of the vehicle was performed; and providing the message in a UI, the person to receive the message through the UI.

Example 2 provides the method of example 1, where the behavior of the vehicle is a change in speed, and determining whether the behavior of the vehicle is undesirable to the person includes determining whether a rate of the change in speed is beyond a predetermined rate limit.

Example 3 provides the method of example 1 or 2, where determining whether the behavior of the vehicle is undesirable to the person includes obtaining personal information that indicates the person's sentiment towards the behavior of the vehicle; and determining whether the behavior of the vehicle is undesirable to the person based on the personal information.

Example 4 provides the method of example 3, where the personal information includes data captured by one or more sensors of the vehicle during the operation of the vehicle, information provided by the person, information about one or more historical rides received by the person, or some combination thereof.

Example 5 provides the method of example 3 or 4, where determining whether the behavior of the vehicle is undesirable to the person includes inputting the personal information and information describing the behavior of the vehicle into a trained model, the trained model outputting a determination of whether the behavior of the vehicle is undesirable to the person.

Example 6 provides the method of example 5, further including receiving a response from the person to the message, the response expressing he person's sentiment towards the behavior of the vehicle; and further training the trained model based on the response, where the response is used to generate a ground-truth label for a training sample including the behavior of the vehicle and the personal information.

Example 7 provides the method of any of the preceding examples, where generating the message includes determining a severity score of the behavior of the vehicle, the severity score indicating an estimated extent of the negative sentiment of the person towards the behavior of the vehicle; and generating the message based on the severity score.

Example 8 provides the method of any of the preceding examples, where the one or more images are generated based on sensor data from one or more sensors of the vehicle that detected the one or more objects in the environment.

Example 9 provides the method of any of the preceding examples, where generating the message includes providing an option in the message for the person to modify the ride.

Example 10 provides the method of any of the preceding examples, where generating the message further includes modifying one or more settings of one or more parts of the vehicle to alert the person of the message.

Example 11 provides one or more non-transitory computer-readable media storing instructions executable to perform operations, the operations including detecting a behavior of a vehicle during an operation of the vehicle for providing a ride to a person; determining whether the behavior of the vehicle is undesirable to the person that would cause a negative sentiment of the person; in response to determining that the behavior of the vehicle is not undesirable to the person, generating a message addressing the behavior of the vehicle, the message comprising one or more images of one or more objects in an environment where the vehicle was operating when the behavior of the vehicle was performed; and providing the message in a UI, the person to receive the message through the UI.

Example 12 provides the one or more non-transitory computer-readable media of example 11, where the behavior of the vehicle is a change in speed, and determining whether the behavior of the vehicle is undesirable to the person includes determining whether a rate of the change in speed is beyond a predetermined rate limit.

Example 13 provides the one or more non-transitory computer-readable media of example 11 or 12, where determining whether the behavior of the vehicle is undesirable to the person includes obtaining personal information that indicates the person's sentiment towards the behavior of the vehicle; and determining whether the behavior of the vehicle is undesirable to the person based on the personal information.

Example 14 provides the one or more non-transitory computer-readable media of example 13, where determining whether the behavior of the vehicle is undesirable to the person includes inputting the personal information and information describing the behavior of the vehicle into a trained model, the trained model outputting a determination of whether the behavior of the vehicle is undesirable to the person.

Example 15 provides the one or more non-transitory computer-readable media of example 14, where the operations further include receiving feedback from the person on the behavior of the vehicle, the person feedback expressing he person's sentiment towards the behavior of the vehicle; and further training the trained model based on the feedback from the person, where the feedback from the person is used as a ground-truth label for a training sample including the behavior of the vehicle and the personal information.

Example 16 provides the one or more non-transitory computer-readable media of any one of examples 11-15, where generating the message includes determining a severity score of the behavior of the vehicle, the severity score indicating an estimated extent of the negative sentiment of the person towards the behavior of the vehicle; and generating the message based on the severity score.

Example 17 provides the one or more non-transitory computer-readable media of any one of examples 11-16, where the one or more images are generated based on sensor data from one or more sensors of the vehicle that detected the one or more objects in the environment.

Example 18 provides the one or more non-transitory computer-readable media of any one of examples 11-17, where generating the message includes providing an option in the message for the person to modify the ride.

Example 19 provides a computer system, including a computer processor for executing computer program instructions; and one or more non-transitory computer-readable media storing computer program instructions executable by the computer processor to perform operations including detecting a behavior of a vehicle during an operation of the vehicle for providing a ride to a person, determining whether the behavior of the vehicle is undesirable to the person that would cause a negative sentiment of the person, in response to determining that the behavior of the vehicle is not undesirable to the person, generating a message addressing the behavior of the vehicle, the message comprising one or more images of one or more objects in an environment where the vehicle was operating when the behavior of the vehicle was performed, and providing the message in a UI, the person to receive the message through the UI.

Example 20 provides the computer system of example 19, where determining whether the behavior of the vehicle is undesirable to the person includes obtaining personal information that indicates the person's sentiment towards the behavior of the vehicle; and determining whether the behavior of the vehicle is undesirable to the person based on the personal information.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
detecting a behavior of a vehicle during an operation of the vehicle for providing a ride to a person;
determining whether the behavior of the vehicle is undesirable to the person that would cause a negative sentiment of the person;
in response to determining that the behavior of the vehicle is not undesirable to the person, generating a message addressing the behavior of the vehicle, the message comprising one or more images of one or more objects in an environment where the vehicle was operating when the behavior of the vehicle was performed; and
providing the message in a user interface, the person to receive the message through the user interface.

2. The method of claim 1, wherein the behavior of the vehicle is a change in speed, and determining whether the behavior of the vehicle is undesirable to the person comprises determining whether a rate of the change in speed is beyond a predetermined rate limit.

3. The method of claim 1, wherein determining whether the behavior of the vehicle is undesirable to the person comprises:
obtaining personal information that indicates the person's sentiment towards the behavior of the vehicle; and
determining whether the behavior of the vehicle is undesirable to the person based on the personal information.

4. The method of claim 3, wherein the personal information comprises data captured by one or more sensors of the vehicle during the operation of the vehicle, information provided by the person, information about one or more historical rides received by the person, or some combination thereof.

5. The method of claim 3, wherein determining whether the behavior of the vehicle is undesirable to the person comprises:
inputting the personal information and information describing the behavior of the vehicle into a trained model, the trained model outputting a determination of whether the behavior of the vehicle is undesirable to the person.

6. The method of claim 5, further comprising:
receiving a response from the person on the behavior of the vehicle, the response expressing he person's sentiment towards the behavior of the vehicle; and
further training the trained model based on the response,
wherein the response is used to generate a ground-truth label for a training sample including the behavior of the vehicle and the personal information.

7. The method of claim 1, wherein generating the message comprises:
determining a severity score of the behavior of the vehicle, the severity score indicating an estimated extent of the negative sentiment of the person towards the behavior of the vehicle;
generating the message based on the severity score.

8. The method of claim 1, wherein the one or more images are generated based on sensor data from one or more sensors of the vehicle that detected the one or more objects in the environment.

9. The method of claim 1, wherein generating the message comprises:
determining whether the behavior of the vehicle would impact a setting of the ride;
after determining that the behavior of the vehicle would impact a setting of the ride, providing an option in the message for the person to modify the setting of the ride.

10. The method of claim 1, wherein generating the message further comprises:
modifying one or more settings of one or more parts of the vehicle to alert the person of the message.

11. One or more non-transitory computer-readable media storing instructions executable to perform operations, the operations comprising:
detecting a behavior of a vehicle during an operation of the vehicle for providing a ride to a person;
determining whether the behavior of the vehicle is undesirable to the person that would cause a negative sentiment of the person;
in response to determining that the behavior of the vehicle is not undesirable to the person, generating a message addressing the behavior of the vehicle, the message comprising one or more images of one or more objects in an environment where the vehicle was operating when the behavior of the vehicle was performed; and
providing the message in a user interface, the person to receive the message through the user interface.

12. The one or more non-transitory computer-readable media of claim 11, wherein the behavior of the vehicle is a change in speed, and determining whether the behavior of the vehicle is undesirable to the person comprises determining whether a rate of the change in speed is beyond a predetermined rate limit.

13. The one or more non-transitory computer-readable media of claim 11, wherein determining whether the behavior of the vehicle is undesirable to the person comprises:
obtaining personal information that indicates the person's sentiment towards the behavior of the vehicle; and
determining whether the behavior of the vehicle is undesirable to the person based on the personal information.

14. The one or more non-transitory computer-readable media of claim 13, wherein determining whether the behavior of the vehicle is undesirable to the person comprises:
inputting the personal information and information describing the behavior of the vehicle into a trained model, the trained model outputting a determination of whether the behavior of the vehicle is undesirable to the person.

15. The one or more non-transitory computer-readable media of claim 14, wherein the operations further comprise:
receiving a response from the person on the behavior of the vehicle, the response expressing he person's sentiment towards the behavior of the vehicle; and
further training the trained model based on the response,
wherein the response is used to generate a ground-truth label for a training sample including the behavior of the vehicle and the personal information.

16. The one or more non-transitory computer-readable media of claim 11, wherein generating the message comprises:
determining a severity score of the behavior of the vehicle, the severity score indicating an estimated extent of the negative sentiment of the person towards the behavior of the vehicle; and
generating the message based on the severity score.

17. The one or more non-transitory computer-readable media of claim 11, wherein the one or more images are generated based on sensor data from one or more sensors of the vehicle that detected the one or more objects in the environment.

18. The one or more non-transitory computer-readable media of claim 11, wherein generating the message comprises:
providing an option in the message for the person to modify the ride.

19. A computer system, comprising:
a computer processor for executing computer program instructions; and
one or more non-transitory computer-readable media storing computer program instructions executable by the computer processor to perform operations comprising:
detecting a behavior of a vehicle during an operation of the vehicle for providing a ride to a person,
determining whether the behavior of the vehicle is undesirable to the person that would cause a negative sentiment of the person,
in response to determining that the behavior of the vehicle is not undesirable to the person, generating a message addressing the behavior of the vehicle, the message comprising one or more images of one or more objects in an environment where the vehicle was operating when the behavior of the vehicle was performed, and
providing the message in a user interface, the person to receive the message through the user interface.

20. The computer system of claim 19, wherein determining whether the behavior of the vehicle is undesirable to the person comprises:
obtaining personal information that indicates the person's sentiment towards the behavior of the vehicle; and
determining whether the behavior of the vehicle is undesirable to the person based on the personal information.
